(19) United States
(12) Patent Application Publication
(10) Pub. No.: US 2004/0250785 A1
(43) Pub. Date: Dec. 16, 2004

(54) Drain hole shape for vessel

(76) Inventors: Toshinori Oba, Hamakita-shi (JP); Yasuhiro Suzuki, Hamakita-shi (JP); Masahiro Ota, Hamakita-shi (JP)

Correspondence Address: YOUNG & THOMPSON, 745 SOUTH 23RD STREET, 2ND FLOOR, ARLINGTON, VA, 22202, US

(21) Appl. No.: 10/494,618

(22) PCT Filed: Dec. 24, 2002
(86) PCT No.: PCT/JP02/13429

(30) Foreign Application Priority Data
Dec. 28, 2001 (JP) 2001-400406

(51) Int. Cl. F02M 35/10; F02M 35/00

(52) U.S. Cl. 123/184.57; 123/198 E; 181/229

(57) ABSTRACT

A vessel having a drain port having a shape improved for preventing formation of water film to the drain port can be provided without making large a diameter of the drain port. In a sectional plane including a center line 6 of the drain port 5, one 7 of wall section constituting the drain port is inclined with respect to another one 8 of wall sections thereof. Accordingly, water can smoothly drops down by its gravity without forming any water film due to surface tension. Furthermore, since the formation of the water film can be prevented without making large a diameter of the drain port, invasion of the water inside the vessel from the outside of the drain port 5 can be also prevented.

### BACKGROUND OF THE INVENTION

The present invention relates to a vessel or container having a drain port having a shape suitable for draining outward water stored in the vessel, and more particularly, a resonator or air cleaner, provided with a drain port having an improved shape, disposed to an intake passage of an engine.

Inside an intake passage of an engine, there are disposed an air cleaner for capturing dust in an intake air and a resonator for reducing noise in the intake passage.

The resonator is branched from the intake passage of the engine and has an inner volume determined in accordance with frequency to be reduced. A resonator has an inner space which is sectioned into a plurality of chambers so as to reduce a plurality of frequencies. On the other hand, an air cleaner is disposed in the intake passage of the engine and is provided with an element therein for capturing dust in the intake air, and the inside space of the air cleaner is sectioned by this element into dust side and clean side.

Air outside the engine is introduced into the intake passage by a negative pressure caused by the operation of the engine. The introduced air passes the resonator and the air cleaner in this order. As water taken inside together with the air is stored in the resonator or air cleaner, the resonator or air cleaner is formed with a drain port or hole for draining water stored inside a casing of the resonator or air cleaner.

A conventional drain port generally has a shape such as cylindrical shape as like as an unloaded hole. In a case of a small diameter of the drain port, a water film will be formed to the drain port due to surface tension, and in a winter season, such water film freezes to thereby close the opening of the drain port. In order to eliminate such fear, it is necessary to make large the diameter of the drain port, which may increase a fear that water may be invaded inside through the drain port.

### SUMMARY OF THE INVENTION

The present invention has an object to solve a problem mentioned above and to provide a vessel having a drain port having an improved shape capable of preventing a water film from being formed to the drain port without making large the diameter thereof.

Hereunder, the present invention will be described. Further, it is to be noted that, in order to easily understand the present invention, although reference numerals on the accompanying drawings are added with parenthesis, the present invention is not limited to the illustrated examples.

The inventor of the subject application found that any water film is not formed to the drain port and water drop smoothly falls outside by forming an inclination to a portion of a wall section constituting drain port (i.e., a wall section on a bottom side constituting a drain port, for example, in a case where a center line of the drain port is substantially directed to a horizontal direction).

That is, the present invention is made to achieve the above object by providing a vessel (1) having a drain port (5) having an improved shape for draining outward water stored in the vessel, wherein one (7) of wall sections constituting the drain port (5) is inclined with respect to another one (8) of the wall sections in a sectional plane including a center line (6) of the drain port (5).

According to the present invention, formation of any water film due to surface tension to a drain port can be avoided and the water smoothly drops outside the drain port. Moreover, since the formation of such water film to the drain port can be prevented without making large the diameter of the drain port, the invasion of water from the outside of the drain port into the inside of a vessel can be also prevented.

Furthermore, according to the present invention, the above object can be also achieved by providing a vessel (1) having a drain port (5) having an improved shape for draining outward water stored in the vessel, wherein the drain port (5) has a center line (6) directed substantially horizontally, and in a perpendicular sectional plane including the center line (6) of the drain port (5), a wall section (7) on a bottom side constituting the drain port (5) is inclined gradually downward towards an outside of the vessel (1).

According to this invention, even in a case where the center line of the drain port directs substantially horizontally, any water film due to the surface tension is not formed and the water can smoothly drops outside the drain port.

One preferred embodiment of the present invention is characterized in that the drain port (5) has a shape such that a virtual cylindrical bottom side thereof is curved downward towards outside the vessel (1).

The vessel having an improved drain-port shape of the present invention may be preferably applied to a resonator (1) or air cleaner (20) of an engine, for example.

### BRIEF DESCRIPTION OF THE DRAWINGS

In the accompanying drawings:

FIG. 1 is a sectional view showing a resonator having a drain port of a shape according to one embodiment of the present invention;

FIG. 2 is a view showing a drain port formed to a side wall of the resonator (that is, a view showing a perpendicular surface section including a center line of the drain port);

FIG. 3 is a view showing the drain port formed to the side wall of the resonator (that is, a plan view of the drain port viewed from an outside thereof)

FIG. 4 shows another example of a drain port (showing a plan view of the drain port viewed from an outside thereof);

FIG. 5 shows a further example of a drain port (showing a perpendicular surface section including a center line of the drain port);

FIG. 6 shows a still further example of a drain port (showing a perpendicular sectional plane including a center line of the drain port);

FIG. 7 shows a still further example of a drain port (showing a vertical surface section including a center line of the drain port); and

FIG. 8 is a sectional view showing an air cleaner having a drain port according to another one embodiment of the present invention.

### DESCRIPTION OF THE PREFERRED EMBODIMENTS

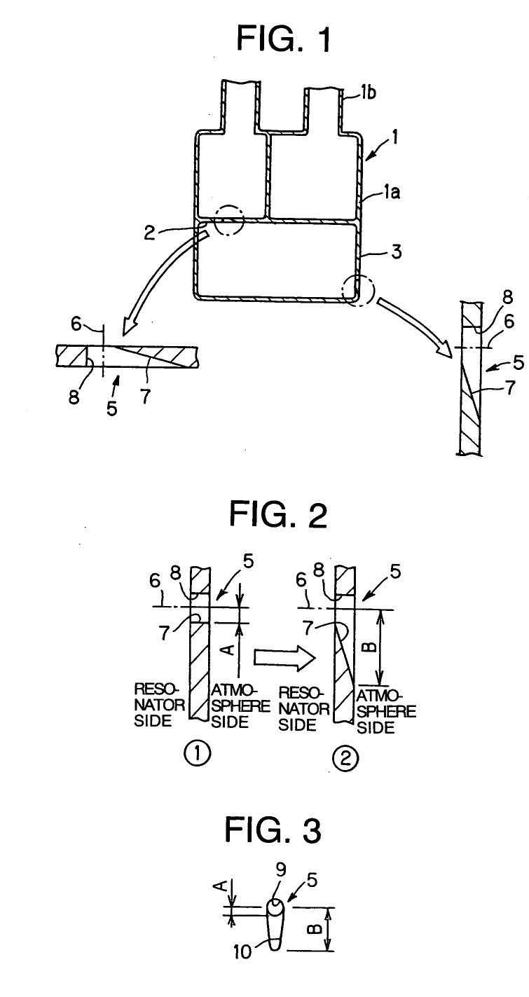

FIG. 1 shows one example of a resonator as vessel provided with a drain port having a shape according to one embodiment of the present invention. The resonator 1 is connected to an intake passage of an engine, not shown. This resonator 1 is formed through a resin blow molding process and comprises a resonator body 1a having a predetermined volume and a cylindrical communication portion 1b acting to communicate the resonator body 1a and the intake passage of the engine. The resonator body 1a may be constructed so as to provide various shapes such as rectangular, cylindrical or like shape. The resonator body 1a has an inner space which is divided into a plurality of sections so as to reduce sounds or noises of a plurality of frequencies. Volumes of the sectioned portions, cross sectional area and length of the communication portion 1b will be determined in accordance with frequencies to be reduced. In the resonator 1 having the structure mentioned above, when pulsation of flow of air passing through the intake passage accords with a resonance frequency of the resonator 1, the resonator 1 resonates, thus reducing the intake noise.

A bottom wall section 2 (wall section disposed in a horizontal plane) or a side wall section 3 (wall section disposed in a vertical plane) exposed outward of the resonator 1 are formed with drain ports or holes 5 for draining outward water stored inside the resonator 1. The bottom wall section 2 and the side wall section 3 are designed so as to have a wall thickness of, for example, about 2.5 mm. The drain ports 5 penetrate the wall thickness direction. The drain port 5 is defined by one wall section 7 and another wall section 8, and the one wall section 7 is inclined with respect to the other wall section 8 in the section including the center line 6 of the drain port 5. The other wall section 8 is approximately perpendicular to inner wall surface of the bottom and side wall sections 2 and 3, to which the drain ports 5 are formed, so as to be in parallel to the center lines 6 of the drain ports 5. The center line 6 mentioned herein is a center line in a supposition that the drain port 5, mentioned hereinlater, has cylindrical or columnar shape, for example. Further, the drain port 5 is molded at the same time as the resonator 1 is molded.

The shape of the drain port 5 will be described in detail hereunder. FIGS. 2 and 3 show the drain port 5 formed to the side wall section 3 of the resonator body 1a. FIG. 2 shows an vertical section including the center line of the drain port 5 and FIG. 3 is a plan view of the drain port 5 viewed from the outside thereof. In FIG. 2, the center line 6 of the drain port 5 is directed substantially horizontal direction. In consideration of the shape of the drain port 5, there is first supposed a virtual cylindrical drain port 5 as shown with \hat{1} in FIG. 2 and as also shown in FIG. 2 with \hat{2}, the wall portion 7 on the bottom wall section 2 of the virtual cylindrical drain port is gradually inclined in the atmosphere side. That is, the wall portion 7 on the bottom wall section 2 constituting the drain port 5 is gradually inclined downward towards the outside of the resonator 1 while maintaining the cylindrical shape of the upper side wall portion 8 also constituting the drain port 5. In this embodiment, the wall portion 7 on the bottom wall section 2 is linearly formed in the elevational sectional plane including the center line 6 of the drain port. According to such structure, as shown in FIG. 3, the drain port 5 has, on the plane surface, a circular portion 9 and a slot portion 10.

In a case of the drain port 5 having a small diameter, a water film is formed to the drain port 5 due to surface tension of the water. A contact angle between the water film and the wall surface of the drain port 5 will maintain substantially constant value due to characters or like of the water, air and wall surfaces. By inclining one wall portion 7 defining the drain port 5 with respect to the other wall portion 8, the formation of the water film can be prevented and the water can hence smoothly drops down by the gravity. Furthermore, without making large the diameter of the drain port 5, the formation of the water film can be prevented, and the inversion of the water inside the resonator from the outside of the drain port 5 can be also prevented.

The inventor of the subject application carried out various experiments for inspecting relationship between the degree of inclination of the wall section 7 constituting the drain port 5 and the draining condition at a time when a drain port having a diameter of 4 mm is formed to the side wall having a thickness of 2.5 mm. From the result of such experiments, as shown in FIG. 2, it was found that water can be smoothly drained in a design that, in a case of the diameter of the drain port 5 of 4 mm (i.e., a distance “A” is 2 mm), by setting a distance “B” from the center of the drain port 5 to the lower end of the wall section 7 to be more than 10 mm. In such design, port diameter (2A):distance (B) from the center of the drain port 5 to the lower end of the wall section 7=1:2.5.

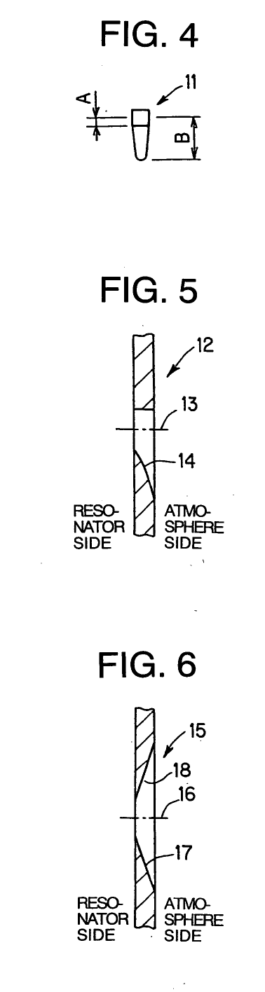

FIG. 4 is an illustration of a drain port 11 having another shape in a plan view seen from the outside thereof. As shown in this FIG. 4, a drain port 11 may have a rectangular shape, other than circular shape, in its plan view. In this shape, the dimensions “A” and “B” are set in accordance with a manner similar to that for the drain port 5 mentioned before. In the rectangular (in plan view) design of the drain port 11, the wall portion thereof has a long peripheral length and, hence, much amount of water can be drained outside. Furthermore, the drain port 11 may be formed so as to provide, in a plan view, triangular shape or polygonal shape such as pentagonal shape.

FIG. 5 shows another example of a drain port 12 having a further different shape, which shows a perpendicular section of the drain port 12 including its center line 13. In this example, the center line of the drain port 12 is directed substantially horizontally. Different from the drain port 5, for the drain port 12 of this example, a wall section 14 on its bottom side is formed so as to provide a circular-arc shape in a perpendicular section including the center line 13 of the drain port 12. The wall section 14 of the bottom side constituting the drain port 12 is positioned so as to incline gradually downward towards the outside of the resonator 1, and in such design, the drain port may have a circular-arc shape.

FIG. 6 shows a further example of the drain port shape, which is a perpendicular section of the wall portion including the center line 16 of a drain port 15. In this example, the center line 16 of the drain port 15 directs also substantially horizontally. Different from the drain port 5, the drain port 15 of this example, the bottom side wall section 17 constituting the drain port 15 is gradually inclined downward towards the outside of the resonator 1, and the upper side wall section 18 also constituting the drain port 15 is gradually inclined upward towards the outside of the resonator 1. That is, the wall surfaces constituting the drain port 15 are tapered so as to be widened in the diameter outward of the resonator 1. In this structure, if the bottom side wall section 17 constituting the drain port 15 is inclined so as to be directed gradually downward towards the outside of the resonator 1, as shown in this example, the upper side wall section 18 constituting the drain port 15 may be inclined gradually upward towards the outside of the resonator 1.

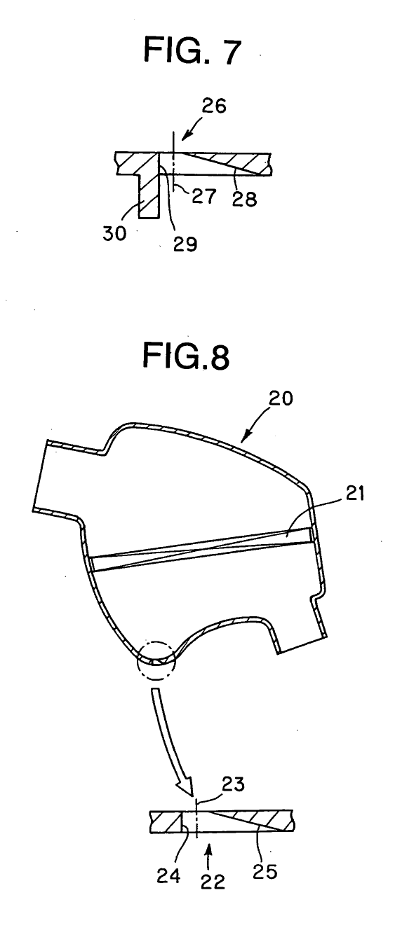

FIG. 7 represents a further example of the drain port having another shape. FIG. 7 shows a vertical section including a center line 27 of a drain port 26. In this example, different from the drain port 5 of the former example, the center line 27 of the drain port 26 is extending substantially in the vertical direction. The drain port 26 of this example is provided with one wall section 28, which is inclined so as to be gradually apart from the center line 27 towards the outside of the resonator 1, and another wall section 29 also constituting the drain port 26 intersects at right angle to an inner wall surface of the resonator 1. Accordingly, the another wall section 29 is extending substantially in the vertical direction. Furthermore, in this example, a rib 30 is formed to the outside wall surface of the resonator 1 so that the thickness of the wall section 29 is larger than the thickness of the resonator 1 itself. The provision of the rib 30 makes it possible to guide water film at more lower position, and hence, water can be easily drained.

FIG. 8 shows an example of an air cleaner 20 as a vessel to which the drain port of the design or shape according to the present invention is applied. The air cleaner 20 has approximately box shape and an element 21 for catching dust is disposed inside the box-shaped air cleaner 20 so as to divide the inner space thereof into two sections, i.e., dust side and clean side sections.

The air cleaner 20 is formed, at its bottom wall section, with a drain port 22 for draining water stored inside the air cleaner 20. In this drain port 22, as like as the drain port 5 formed to the bottom wall 2 of the resonator 1, one wall section 25 constituting the drain port 22 is inclined with respect to the other wall section 24 in a sectional plane including the center line 23 of the drain port 22. Such design of the drain port according to the present invention may be applied to the air cleaner.

Further, it is to be noted that the present invention is not limited to the resonator or air cleaner of the structure mentioned above, but is applicable to various parts or members having drain structures.

As described above, according to the present invention, since one wall section constituting the drain port is inclined with respect to the other wall section in a sectional plain including the drain port, water can smoothly drops outside by the gravity without forming a water film to the drain port due to surface tension. In addition, the formation of the water film can be prevented without making large the diameter of the drain port, so that invasion of the water into the vessel from the outside of the drain port can be prevented.

1. A vessel having a drain port for draining outside water stored in the vessel, wherein one of wall sections constituting the drain port is along its total length inclined with respect to another one of wall sections thereof to gradually go away from said another one of wall sections thereof in a sectional plane including a center line of the drain port.

2. A vessel having a drain port for draining outside water stored in the vessel, wherein the drain port has a center line directed substantially horizontally and, in a perpendicular sectional plane including the center line of the drain port, a bottom side wall section constituting the drain port is inclined gradually outward downward.

3. The vessel having a drain port according to claim 2, wherein the drain port has a shape having a virtual cylindrical bottom side portion curved outward downward of the vessel.

4. The vessel having a drain port according to claim 1, wherein said vessel is a resonator disposed in an intake path of an engine for reducing noise or an air cleaner disposed in the intake path of the engine for catching duct.

5. The vessel having a drain port according to claim 2, wherein said vessel is a resonator disposed in an intake path of an engine for reducing noise or an air cleaner disposed in the intake path of the engine for catching duct.

6. The vessel having a drain port according to claim 3, wherein said vessel is a resonator disposed in an intake path of an engine for reducing noise or an air cleaner disposed in the intake path of the engine for catching duct.
